(19) United States
(12) Patent Application Publication
(10) Pub. No.: US 2017/0278150 A1
(43) Pub. Date: Sep. 28, 2017

(54) METHOD AND SYSTEM FOR FACILITATING PLACEMENT OF AN ORDER

(71) Applicant: Eric S Tucker, Lees Summit, MO (US)

(72) Inventor: Eric S Tucker, Lees Summit, MO (US)

(21) Appl. No.: 15/622,011

(22) Filed: Jun. 13, 2017

Related U.S. Application Data
(63) Continuation-in-part of application No. 15/087,749, filed on Mar. 31, 2016.
Application No. 15/087,749 is a continuation-in-part of application No. PCT/IB2017/051611, filed on Mar. 20, 2017.
(60) Provisional application No. 62/349,247, filed on Jun. 13, 2016.
(60) Provisional application No. 62/140,665, filed on Mar. 31, 2015.

(51) Int. Cl. G06Q 30/06; G06Q 50/12; G06Q 20/32; H04W 4/02

(52) U.S. Cl. CPC G06Q 30/06; H04W 4/02; G06Q 50/12; G06Q 20/322; G07G 1/12

(57) ABSTRACT

Disclosed is a method of facilitating placement of an order at a restaurant. The method may include receiving at least one message comprising the order from a user device. Further, the method may include transforming the at least one message into a structured order. Furthermore, the method may include detecting at least one location of the user device based on a communication between the user device and at least one transceiver. Further, the at least one transceiver may be configured to perform one or more of transmission and reception of electromagnetic waves. Additionally, the method may include transmitting the order to the user device and receiving a confirmation of the order from the user device. Further, the method may include performing at least one action on the at least one message based on the at least one location of the user device and the confirmation of the order.

### FIELD OF INVENTION

The present disclosure generally relates to communication using personal devices. More specifically, the disclosure relates to systems and methods for facilitating users to place orders using a personal device such as a mobile phone.

### BACKGROUND OF INVENTION

People often travel by car and use restaurants to eat on the go, using the drive-through or getting food inside the store or in the parking lot. The drive-through is the most popular among fast food restaurants. However, the drive-through can be burdensome to use sometimes, but a necessary evil when on the go, and food or drink is required. The conventional drive-through may be based on two-way voice communication, where the order may be taken using a customer dialog. The two-way voice dialog may result in unavoidable miscommunication, through human error or equipment malfunction, which may significantly reduce the speed of service and customer satisfaction.

Certain drive-through systems use handheld devices for ordering but are given to servers and employees of the restaurant. The handheld devices are not used by customers. Furthermore, certain restaurants provide an internet web portal and mobile phone applications for online food ordering by providing a list of restaurants within a particular location. However, placing orders at the drive-through using one's mobile phone has challenges. Firstly, people may not want a stranger to have their mobile phone number or other personal information; secondly, drive-through may face difficulties in maintaining order in the line of the customer's orders. Further, the existing processes are cumbersome and require additional software components for placing orders by a phone app.

Therefore, the current solutions require the users to download and install complex applications to the user's personal device. Moreover, current solutions do not offer a guest check out approach thus protecting the privacy of a customer while placing an order for those customers who prefer to order with mobile but do not want to provide personal information.

As a result, there exists a need for systems and methods for facilitating placement of an order at a restaurant that enhance quality, efficiency, and customers' satisfaction by providing an order in advance, and removing human error in the order-taking and order-fulfillment process.

### SUMMARY OF INVENTION

It is an object of the present disclosure to provide a method and system of communication that allows users to place orders on premise or in advance using a personal device and getting the order while being inside the restaurant using a personal device. Alternatively and/or additionally, the object is to enable the users to place orders on premise or in advance while getting the order in the parking lot using a personal device and having the order delivered to the users where they are parked.

Additionally, it is an object of the present disclosure to provide a method and system of facilitating processing of an order based on one or more locations of a user and/or the user device in the drive-through.

Further, it is also an object of the present disclosure to provide a variety of techniques of detecting the one or more locations of the user and/or the user device in relation to the restaurant in order to facilitate processing and delivery of the order.

Furthermore, it is an object of the present disclosure to facilitate order placement using the personal device's built in apps and services without requiring a mobile application be installed first. However, the user may be prompted to install a small utility on the personal device (e.g. smartphone) that may communicate data including, but not limited to, location data. However, the order placement may continue to take place anonymously in a messaging app like SMS or other messaging app/service. Further, no personal data may be transmitted to the restaurant or its employees. However, in some cases, like providing mobile payment capability, some personal data may be required should the customer want certain features.

One embodiment of the present application describes a method of facilitating placement of an order at a restaurant. The method may include receiving, using a communication unit, at least one message from a user device. Further, the at least one message may include the order. Furthermore, the method may include transforming, using a processor, the at least one message into a structured order. Additionally, the method may include detecting, using the processor, at least one location of the user device based on a communication between the user device and at least one transceiver. Examples of the at least one transceiver include, but are not limited to, a cell tower, a WiFi access point, a beacon, GPS satellite and any other form of communication device capable of communicating with the user device in order to facilitate detection of the at least one location. Further, the at least one transceiver may be configured to perform one or more of transmission and reception of electromagnetic waves. Furthermore, the method may include transmitting, using the communication unit, the order to the user device. Additionally, the user device may be capable of presenting the order. Further, the method may include receiving, using the communication unit, a confirmation of the order from the user device. Furthermore, the method may include performing, using the processor, at least one action on the at least one message based on the at least one location of the user device and the confirmation of the order.

Another embodiment of the application describes a system for facilitating placement of an order at a restaurant. The system may include a communication unit configured for receiving at least one message from a user device. Further, the at least one message may include the order. Furthermore, the communication unit may be configured for transmitting the order to the user device. Accordingly, the user device may be capable of presenting the order. Further, the communication unit may be configured for receiving a confirmation of the order from the user device. Additionally, the system may include a processor configured for transforming the at least one message into a structured order. Further, the processor may be configured for detecting at least one location of the user device based on a communication between the user device and at least one transceiver. Furthermore, the at least one transceiver may be configured to perform one or more of transmission and reception of electromagnetic waves. Additionally, the processor may be configured for performing at least one action on the at least one message based on the at least one location of the user device and the confirmation of the order.

Certain embodiments of the disclosure may provide various technical advantages. For example, certain implementations may provide greater security and privacy to the user maintaining anonymity of the user than do present communication and ordering systems. As embodiments of the claimed invention do not require any special applications on the user's personal device to create and send an order, users may conveniently place orders without the hassle of installing an additional mobile application. Standard features of a personal device such as SMS, email or standard web browser may facilitate the desired functionality, or the user may choose to use another messaging app if they prefer. Additionally, since one embodiment of the system may mediate communication of the order from the user to an order-taker, personal information of the user may be kept private maintaining complete anonymity of the user. Furthermore, by using a variety of detection techniques based on, such as, but not limited to, cell tower triangulation, GPS, WiFi, RF beacon, NFC, Bluetooth, proximity sensors etc., one or more locations of the user and/or the user device may be automatically detected and the order may be processed based on the one or more locations. Accordingly, efficiency of order processing at the restaurant may be enhanced while maintaining timely delivery of service to the user without imposing any burden on either the user or the restaurant's staff.

The system may advantageously improve user satisfaction and speed of service by reducing miscommunication and transmitting order information between the user and the directly to the POS and/or kitchen, by passing the order-taker.

In some embodiments, the system may provide an electronic wallet based payment option reducing the order completion time by minimizing the time of the transaction taking place at the drive-through window.

These and other advantages, features, and objects of the claimed application will become apparent upon review of the following detailed description of the preferred embodiments when taken in conjunction with the drawings and the appended claims.

### BRIEF DESCRIPTION OF DRAWINGS

Exemplary embodiments of the present invention are described hereinafter with reference to the following drawings.

FIG. 1 is a schematic representation of a system configured to facilitate placement of an order in accordance with some embodiments.

FIG. 2 is a flow chart illustrating an exemplary method for facilitating placement of an order in accordance with some embodiments.

FIG. 3 illustrates a flow chart of a method of facilitating placement of order in a drive-through based on location of user device in accordance with some embodiments.

FIG. 4 illustrates a flow chart of a method of facilitating placement of order in a restaurant by receiving a message comprising the order and performing at least one action on the message based on at least one location of the user device in accordance with some embodiments.

FIG. 5 illustrates a flow chart of a method of determining one or more locations of a user device using one or more transceivers at one or more predefined positions transmitting electromagnetic waves to the user device for facilitating placement of order in a restaurant, in accordance with some embodiments.

FIG. 6 illustrates a flow chart of a method of determining one or more locations of a user device using one or more transceivers at one or more predefined positions detecting electromagnetic waves transmitted by the user device for facilitating placement of order in a restaurant, in accordance with some embodiments.

FIG. 7 illustrates a flow chart of a method of determining one or more locations of a user device using GPS for facilitating placement of order in a restaurant, in accordance with some embodiments.

FIG. 8 illustrates a layout view of a drive-through depicting one or more transceivers configured to detect one or more positions of the user device in accordance with some embodiments.

While embodiments of the present disclosure are amendable to various modifications and alternative forms, specific embodiments are shown by way of example in the drawings and are described in detail. It should be understood, however, that the drawings and detailed description thereto are not intended to limit the present disclosure to the particular form disclosed, but on the contrary, the intention is to cover all modifications, equivalents, and alternatives falling within the spirit and scope of the present disclosure as defined by the appended claims.

### DETAILED DESCRIPTION OF INVENTION

The following detailed description is made with reference to the figures. Embodiments are described to illustrate the disclosed system and method, not to limit their scope.

Overview

Embodiments of the present application are directed to systems and methods for facilitating placement of an order at a restaurant.

Embodiments of the present application relate to methods and systems of communication that allow users to place orders (anonymously or otherwise) to be picked up in a drive-through, in the restaurant, or the parking lot using a personal device such as a mobile phone. The user may use the built in apps and services of the personal device to communicate by SMS/messaging, email, or internet, whichever is available on the personal device. The user may not be required to download and/or install any additional mobile application on the personal device to create and send the order. However, the user may be prompted to install a small utility on the user device (e.g. smartphone) that may communicate certain data including, but not limited to, location data. However, the order placement may continue to take place anonymously in a messaging app like SMS or other messaging app/service. Further, no personal data may be transmitted to the restaurant or its employees. However, in some cases, like providing mobile payment capability, some personal data may be required should the customer want certain features.

The user may initiate communication by sending a message to a system implemented as a “store and forward” system via Short Messaging Service (SMS)/messaging, email or internet. The system may hold the message based on predetermined rules until the user reaches a certain pre-determined place in the drive-through line, inside the restaurant or in the parking lot and has confirmed the order at which time the system may forward the order to the restaurant's order taker or POS system.

Based on the location data and in some instances confirmation of the order from the user, the system may perform actions on the message including forwarding the message to the store system/POS/order-taker, cleaning/modifying messages before forwarding, or replying to the user. On forwarding the message to the store system/POS/order-taker, the system may not display phone number or personal information of the user to the store system/POS/order-taker. Additionally, the store and forward system, based on predetermined rules, may select parts of the messages that are relayed back and forth between the store system/POS/order-taker and the user. For instance, before a message is forwarded, the message may go through a cleanup process to remove any unwanted language or unnecessary words to facilitate the order transaction and provide a clean structured order for entry to the store's systems. Furthermore, the system may reply to the user with predetermined messages to clarify information or confirm the order.

In some embodiments, the user may not be registered or known by the system or store system/POS/order-taker. However, the system may store a plurality of information about the store system/POS/order-taker's business. Further, a direct communication link may not be established between the user and store system/POS/order-taker.

Exemplary Systems

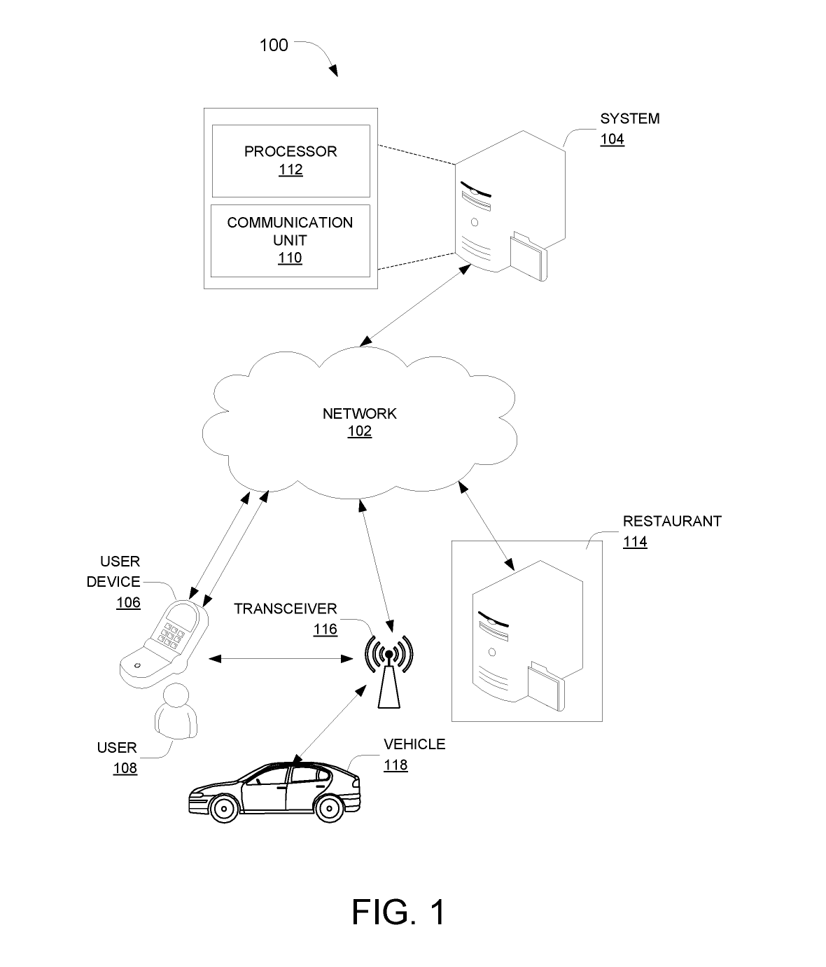

FIG. 1 illustrates an exemplary environment 100 in which the subject matter of the disclosure can function. The environment 100 generally includes a network 102 communicatively coupling a system 104 to one or more user devices 106. Users 108 may operate user devices 106 to place an order from a restaurant 114 using the system 104. Additionally, the network 102 communicatively couples the system 104 to the restaurant 114 which may include an order-taker device. The user 108 may initiate an order request with the system 104 using any of the one or more user devices 106.

The network 102 generally refers to any interconnecting system capable of transmitting audio, video, signals, data, messages, or any combination of the preceding. Further, the network 102 may include all, or a portions of a public switched telephone network (PSTN), a public or private network, a local area network (LAN), a metropolitan area network (MAN), a wide area network (WAN), a local, regional, or global communication or computer network such as the Internet, a wired or wireless network, an enterprise intranet, other suitable communication link, or any combination of similar systems.

The system 104, in some embodiments, may be a store and forward message server for receiving and catering to order requests from the user 108 and/or the restaurant 114. The system 104 may include, for example, a web server, a computer workstation, or any other device operable to dynamically receive message comprising order requests from the user device 106 and facilitate placement of the order at the restaurant 114. Further, the system 104 may use any appropriate operating system, such as MS-DOS®, MAC-OS®, WINDOWS®, UNIX®, including operating systems developed hereafter.

As used here, the term user device 106 generally refers any suitable device operable to communicate with the system 104 and the restaurant 114 through the network 102. Accordingly, the restaurant 114 may include a server computer configured to communicate through the network 102. Further, the user device 106 may employ any known operating systems such as MS-DOS®, PC-DOS®, OS-2®, MAC-OS®, or any other appropriate operating systems. The user device 106 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the system 104 through the network 102.

The user device 106 may include a user interface for interacting with the system 104 and placing order requests. Using the user interface, the user 108 may select a specific restaurant 114 along a destination route. The user device 106 may also include a user input device that allows the user 108 to interact with the user device 106. The user input device may take a variety of forms, such as a touch-screen, button, keypad, dial, etc. Further, the user device 106 may include a display screen to display information to the user.

The system 104 may include a communication unit 110, a processor 112, and in some embodiments, storage (not shown in figure). The communication unit 110 may be communicatively coupled to the processor 112 and may be configured to communicate with the user device 106 associated with the user 108. The communication unit 110 may connect the system 104 to the network 102 for receiving order requests from the user device 106 and servicing the order requests in cooperation with the restaurant 114.

The communication unit 110 may refer to any suitable device capable of receiving a message and/or sending a message from the system 104. For example, the communication unit may include appropriate hardware modem, network interface card, and similar devices. Further, the software capabilities of the communication unit 110 may include protocol conversion and data processing capabilities, to communicate through a LAN, WAN, or other communication system, allowing the system 104 to communicate to other devices. Moreover, the communication unit 110 may include one or more ports, conversion software, or both.

The processor 112 can be any suitable device capable of executing instructions and manipulating data to perform operations for the system 104. The processor 112 may be utilized for processing requirements of the system 104. Processor 112 may include microprocessors, microcomputers, microcontrollers, digital signal processors, central processing units, state machines, logic circuitries, and/or any devices that manipulate signals based on operational instructions. For example, processor 112 may be any central processing unit (CPU), such as such as the Pentium processor, the Intel Centrino processor, and so on.

The storage may be divided into one or more program(s) and data. The data includes various data banks for storing different data. The programs store various program modules designed to dynamically receive and cater to order requests made by user 108 corresponding to the restaurant 114. For example, the storage may store restaurants located in a geographic area and the corresponding menu including the items offered by the restaurant. The storage may also include information on other businesses located on a highway and the nearby areas. Further, the storage may be any suitable device capable of storing computer-readable data and instructions. For example, the storage may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

The restaurant 114 may be a drive-through business allowing customers to purchase products without leaving their automobile vehicle. The restaurant 114 may include a microphone, CCTV camera, a carhop, drive lanes, and the like for the user 108 for detecting the location of the user 108 to facilitate timely processing and/or delivery of the food item. The restaurant 114 may execute the requested order, provided by the system 104. The restaurant 114 may also provide an access control for verifying the user 108 and delivering correct orders.

Additionally, the system 100 may include one or more transceivers 116 configured to perform at least one of transmission and reception of electromagnetic waves, such as, but not limited to, radio waves, IR waves and visible light. Accordingly, the one or more transceivers 116 may be configured to communicate with the user device 106 in order to facilitate detection of one or more locations of the user device. Further, in an instance, the one or more transceivers 116 may be placed at one or more predefined positions at the restaurant. For example, the one or more predefined positions may correspond to parking lot, entry/exit of drive-through lane, order-taker station, intercom station, order-delivery station, POS terminal and so on.

Further, in some embodiments, the one or more transceivers 116 may be configured to communicate through the network 102 with one or more of the user device 106 and the restaurant 114. Furthermore, the one or more transceivers 116 may be configured to communicate with a control system of a vehicle 118. For example, the control system may include, for example, vehicle navigation unit configured for detecting location of the vehicle using a GPS receiver. In addition, the control system may include one or more sensors configured to detect vehicle related parameter such as speed, direction of movement, acceleration, engine operation status etc. and communicate the vehicle related parameters to the one or more transceivers 116.

In addition, the system 100 may include one or more sensors (not shown in the figure), such as proximity sensors configured to detect proximity of the vehicle 114 to the one or more predefined positions. For instance, load sensors may be placed on the drive-through lane in order to detect the presence of the vehicle. Alternatively, the proximity sensors may include magnetic/electromagnetic sensors that may detect presence of the metallic parts of the vehicle 114. Further, in some embodiments, the user device 106 may be configured to detect magnetic field (static and/or varying according to a pattern) generated by one or more magnets/electromagnets placed at the one or more predefined positions. Accordingly, the user device 106 may determine its location based on the magnetic field detected.

In operation, the user 108 may initiate an order request using a standard messaging application on the user device 106. To this end, the user 108 may use the user device 106 to send an order request to the system 104. Accordingly, the system 104 may receive a message from the user device 106 corresponding to the order request. The message may include the order to be placed with the restaurant 114.

In some embodiments, the user 108 may send the message to the system 104 using a Short Messaging Service (SMS), an e-mail, or an internet based message. For instance, the user 108 may type an SMS, including the order, from the user device 106 and send to the system 104.

In another embodiment, the user 108 may use message service from Facebook Messenger, WhatsApp, Google Hangout, Apple iMessage, Skype, Twitter and the like. The system 104 may be configured to receive messages and recognize order requests from such internet based message services.

Additionally, the system 104 may be configured for detecting at least one location of the user device based on a communication between the user device and the at least one transceiver 116. Further, the system 104 may be configured for performing at least one action on the at least one message based on the at least one location of the user device and confirmation of the order received from the user device 106.

Accordingly, in some embodiments, the processor 112 may forward the message to an order-taker device of the restaurant 114 based on the at least one location of the user device 106, such as vicinity of the restaurant and/or entry of the drive-through lane. The processor 112 may determine that the message is an order request from the user 108 and may communicate the message to the communication unit 110. On receiving, the communication unit 110 may forward the message to the order-taker device of the restaurant. In an exemplary embodiment, the processor 112 may forward the message, as it is, without making any changes to the message to the communication unit 110. In another embodiment, the processor 112 may parse the message and recognize the content specifying the order included in the message. On recognizing and identifying the relevant content, the processor 112 may modify the message for easier and faster processing of the order request by the order-taker device of the restaurant 114.

In some embodiments, the processor 112 may filter the message to remove at least one of unwanted language and an unnecessary word. Accordingly, the processor 112 may filter the message and forward the filtered message to the communication unit 110. To this end, the processor 112 may parse the message and recognize the content specifying the order included in the message. On recognizing and identifying the relevant content, the processor 112 may filter the message to remove unwanted language and unnecessary words which may be of no use to the order-taker device of the restaurant 114. Thus, the filtered message may help in faster and accurate processing of the order.

Further, in some embodiments, the processor 112 may transform the message into a structured order based on at least one of text processing and speech processing. For instance, based on the Natural Language Processing (NLP) technique, the processor 112 may transform the message into a structured order. Use of such techniques offer the advantage of taking a speech order from the order station and handling it via a computer system without requiring human employee involvement.

Additionally, in some embodiments, the processor 112 may compare a portion of the message with at least one data element of a menu associated with the restaurant and may generate a structured order based on a result of the comparing. The processor 112 may access the menu associated with the restaurant stored in the storage of the system 104. On accessing, the processor 112 may compare the message with the elements of the menu for a restaurant. The processor 112 may utilize a suitable comparison algorithm for arriving at the result. Based on a result of the comparison, the processor 112 may generate the structured order and communicate the structured order to the communication unit 110. Further, in some embodiments, the communication unit 110 may transmit the structured order to the user device 106 and/or a presentation device associated with the restaurant 114. Accordingly, the user 108 may review the order.

In some embodiments, the processor 112 may perform an action on the message based on at least one predetermined rule. The processor 112 may run a predetermined rule prior to performing an action on the message. The predetermined rule may be stored in the storage of the system 104. The processor 112 may access the predetermined rule from the storage and apply them.

The predetermined rule may be any rule that dictates when and what actions are performed based on the message. In a scenario, a predetermined rule may specify that when the order meets certain predefined criteria, the order may be handled according to a set protocol. For example, the user may be driving on a national highway of a particular state, say California. Then, a predetermined rule may be set specifying that the favorite food of California, such as fish tacos, may be offered with the order as complementary to the user without any additional charges. In another scenario, the predetermined rule prohibiting sale of liquor during specific hours may be set to prevent accidents. Moreover, on specific routes or in specific districts of a state, predetermined rules may prohibit sale of liquor, which have statistically recorded accidents. In another example, when the user may order from a specific restaurant, then predetermined rule may be set for offering specialties of the restaurant on receiving an order above a specific dollar value.

Furthermore, the predetermined rule may be set which may mandate identity of the user 108 in certain geographic locations. Such a rule may be set keeping in view the crime history of the geographic area. Hence, on receiving the user identity and determining that the user 108 is not in the fugitive or terrorist list, an appropriate action may be taken on the message. Thus, the predetermined rule serves an advantageous function of performing an appropriate action on the message based on the situation. The action on the message may be different based on a specific test condition and resulting action specified by the predetermined rule.

In some embodiments, the system 104 may present the order to the user 108 on the user device 106 for confirmation. Accordingly, the user 108 may review the order and provide an input representing confirmation of the order. The confirmation of the order may then be conveyed to the system 104 in the form of a conformation message.

In some embodiments, the restaurant 114 may send purchase information including information such as items ordered, the price, the delivery time, and the like to the user 108. The purchase information may be presented to the user 108 on the user device 106.

In some embodiments, the user 108 may make the payment for the order from the user device 106. The user device 106 may have an associated electronic wallet. The processor 112 may determine that the electronic wallet has sufficient funds to make the payment for the order. If the user 108 does not have sufficient funds, then the system 104 may request the user 108 to credit sufficient funds to the electronic wallet. If the user 108 does not credit sufficient funds, then the order may not be delivered to the user 108. If the electronic wallet is credited with sufficient funds, the order may be delivered to the user 108.

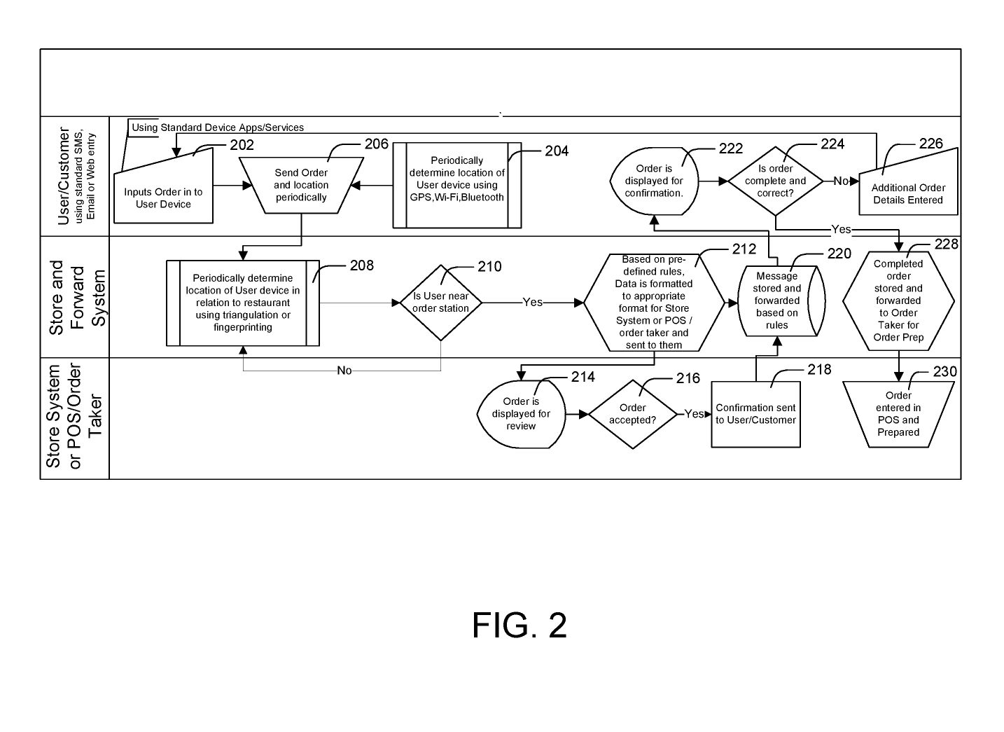

FIG. 2 illustrates an exemplary method 200 for facilitating anonymous placement of an order at the restaurant 114 for the user 108. The exemplary method 200 is described with reference to the environment 100 and the system 104 explained in FIG. 1. These exemplary methods may be described in the general context of computer executable instructions. Generally, computer executable instructions can include routines, programs, objects, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

In FIG. 2, the process begins at step 202, where the system 104 may receive a message from the user device 106 corresponding to a request for an order placement. The message may include the order to be placed with the restaurant 114. To this end, the user 108 may use the user device 106 to send an order request to the system 104. The user 108 may initiate the order request using a standard messaging application on the user device 106.

In some embodiments, the user 108 may send the message to the system 104 using a Short Messaging Service (SMS), an e-mail, or an internet based message. For instance, the user 108 may type an SMS, including the order, from the user device 106 and send to the system 104.

In some embodiments, the user 108 may send an internet based message such as a message from Facebook Messenger, WhatsApp, Google Hangout, Apple iMessage, Skype, Twitter, and the like. The system 104 may be configured to receive messages from such internet based message services. Further, the system 104 may be configured to recognize the order request from such message and parse the content of the message.

Additionally, in some embodiments, subsequent to receiving the message, one or more operations may be performed on the message. For instance, a transformation of the message into a structured order may be performed. As an example, the message may be parsed using a language model based parser and subsequently converted into a message according to a predefined format. As another example, in case the message is in the form of speech, speech processing may be performed on the message in order recognize spoke words and subsequently convert the message into a structured order.

Moving to the step 204, the system 104 may periodically determine one or more locations of the user device 106 using one or more detection techniques, such as, but not limited to, GPS, WiFi, NFC, Bluetooth etc. Accordingly, at step 206, the order may be transmitted to the “store and forward system” in addition to location data transmitted periodically.

The method 200 continues to step 208 where the system 104 may periodically determine location of the user device 106 in relation to the restaurant, using for example, but not limited to, triangulation and/or fingerprinting. For example, three or more transceivers 116 placed at predetermined positions may each receive a predetermined electromagnetic signal, such as coded radio waves, from the user device 106. Accordingly, based on strengths of signals received at each of the three or more transceivers 116, triangulation may be performed in order to determine location of the user device 106 in relation to the restaurant. Alternatively, fingerprinting may involve one or more transceivers 116 placed at predetermined positions and configured to transmit one or more unique electromagnetic waves (i.e. electromagnetic fingerprints) over a short range. In other words, each of the one or more transceivers may function as short range radio beacons. Accordingly, the user device 106 in vicinity of the one or more transceivers 116 may be configured to detect a respective electromagnetic fingerprint and transmit the electromagnetic fingerprint to the “store and forward system”. Accordingly, the location of the user device 106 may be determined based on the respective electromagnetic fingerprint.

Further, at step 210, a determination is made of whether or not the user device 106 is near the order station. If the result of the determination is negative (i.e. No), then execution returns to step 208. However, if the result of the determination is positive (i.e. Yes), then execution proceeds to step 212. Accordingly, at step 212, based on predefined rules, the message may be formatted to be compatible with “the store and forward system” and/or the POS/order-taker. Further, the formatted message may then be transmitted to POS/order-taker.

At step 214, the system 104 may present the order to the user 108 on the user device 106. In some embodiments, the order may be presented to the user 108 at a location of the restaurant 114. The location information may include at least one of a drive-through lane, an intercom station, an interior of the restaurant, an order station and POS terminal. Alternatively, in some embodiments, the order may be presented to the user 108 on the user device 106. Accordingly, the user 108 may review the order.

Further, at step 216, a determination is made of whether the order is accepted. If accepted, at step 218 a confirmation is sent to the user device 108 and execution moves to step 220. At step 220, the message may be stored and forwarded based on rules.

In some embodiments, the forwarding of the message may be directed to an order-taker device of the restaurant 114. Accordingly, the processor 112 may determine that the message is an order request from the user 108. Further, based on proximity of the user device 106 near the order station, the processor 112 may communicate the message to the communication unit 110. On receiving, the communication unit 110 may forward the message to the order-taker device of the restaurant. In an exemplary embodiment, the processor 112 may forward the message, as it is, without making any changes to the message to the communication unit 110. In another embodiment, the processor 112 may parse the message and recognize the content specifying the order included in the message. On recognizing and identifying the relevant content, the processor 112 may modify the message for easier and faster processing of the order request by the order-taker device of the restaurant 114.

In some embodiments, the processor 112 may perform an action on the message based on one or more predetermined rules. The processor 112 may run a predetermined rule prior to performing an action on the message. Based on the predetermined rule, the processor 112 may perform an action on the message. The action on the message may be different based on a specific test condition and an action of the predetermined rule. The predetermined rule may be stored in the storage of the system 104. The processor 112 may access the predetermined rule from the storage and apply them.

In some embodiments, the processor 112 may be configured to perform filtering the message to remove one or more of unwanted language and an unnecessary word. Accordingly, the processor 112 may be configured to modify the message and forward the modified message to the communication unit 110. The processor 112 may parse the message and recognize the content specifying the order included in the message. On recognizing and identifying the relevant content, the processor 112 may modify the message. Thus, the modified message may help in faster and more accurate processing of the order.

In some embodiments, the processor 112 may transform the message into a structured order based on one or more of text processing and speech processing. For instance, based on a Natural Language Processing (NLP) technique, the processor 112 may transform the message into a structured order.

In another embodiment, the processor 112 may compare a portion of the message with at least one data element of a menu associated with the restaurant. Based on the comparison, the processor 112 may generate a structured order. The processor 112 may access the menu associated with the restaurant stored in the storage of the system 104. On accessing, the processor 112 may compare the message with the elements of the menu for a restaurant. Based on a result of the comparison, the processor 112 may generate the structured order and communicate the structured order to the communication unit 110. The communication unit 110 may then transmit the structured order to the user device 106 and/or a presentation device associated with the restaurant 114.

At step 222, subsequent to formatting and/or transforming the message, the order may be displayed for confirmation from the user. Accordingly, at step 224 a determination may be made of whether the order is complete and correct. If the result of the determination is negative (i.e. No), the user may be prompted to enter additional order details at step 226. However, if the determination is positive (i.e. Yes), execution proceeds to 228 where the completed order is stored and forwarded to order-taker for order preparation. Subsequently, at step 230, the order is entered in POS and prepared.

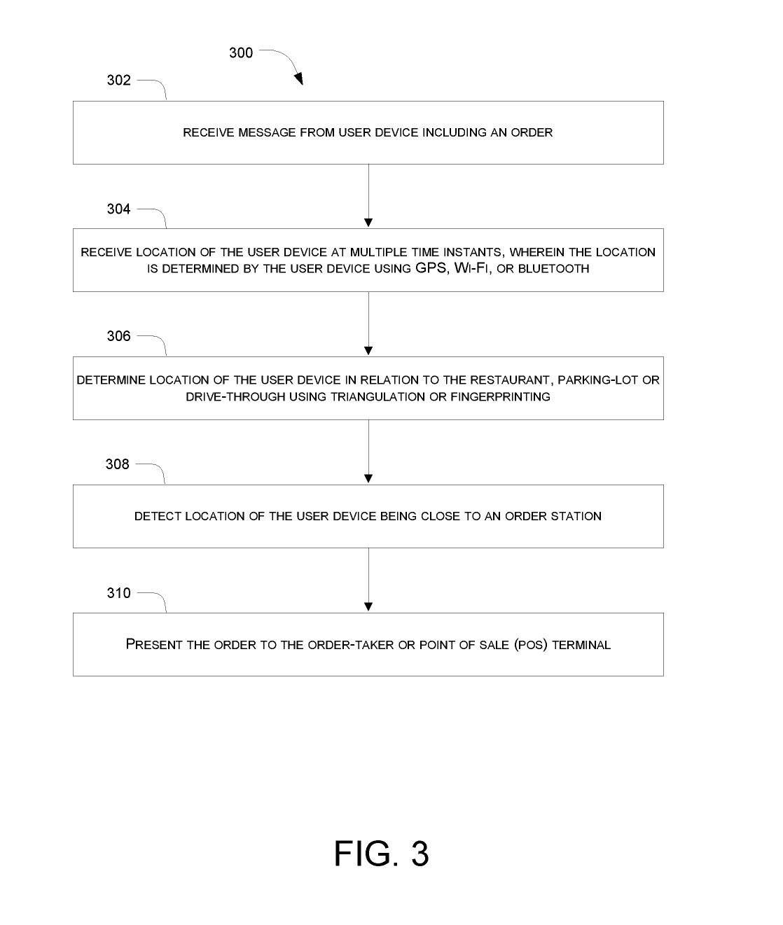

Turning now to FIG. 3, a flow chart of a method 300 for facilitating placement of an order in a drive-through according to some embodiments is illustrated. At step 302, the system 104 may receive a message including an order from user device 106. Further, at step 304, the system 104 may receive location of the user device 106 at multiple time instants. In an instance, the location may be determined by the user device 106 using detection techniques based on, for example, but not limited to, GPS, Wi-Fi, Bluetooth etc. Furthermore, at step 306, the system 104 may determine location of the user device 106 in relation to the restaurant, parking-lot or drive-through using triangulation or fingerprinting. Further, at step 308, the system 104 may detect location of the user device 106 being close to an order station. Accordingly, at step 310, the system 104 may present the order to the order-taker or point of sale (POS) terminal.

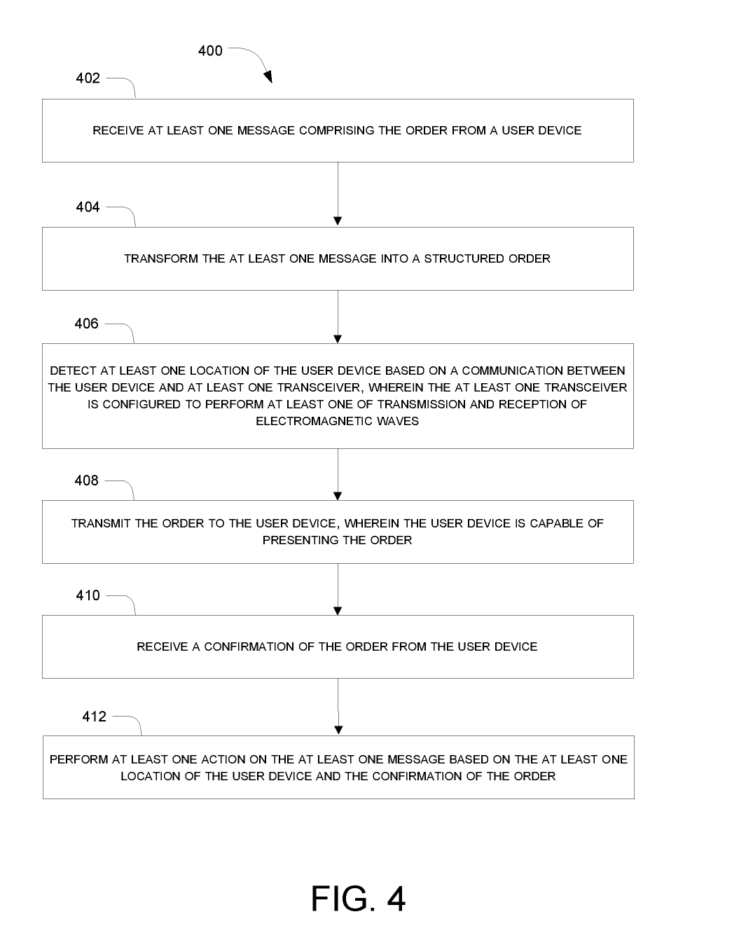

FIG. 4 illustrates a flow chart of a method 400 of facilitating placement of order in a restaurant by receiving a message comprising the order and performing at least one action on the message based on at least one location of the user device in accordance with some embodiments. The method 400 may include a step 402 of receiving, using a communication unit, at least one message from a user device. Further, the at least one message may include the order. Furthermore, the method 400 may include a step 404 of transforming, using a processor, the at least one message into a structured order. Additionally, the method 400 may include a step 406 of detecting, using the processor, at least one location of the user device based on a communication between the user device and at least one transceiver. Further, the at least one transceiver may be configured to perform one or more of transmission and reception of electromagnetic waves.

The step 406 of detecting may use a variety of techniques of sensing one or more locations of the user and/or the user device in relation to the restaurant. In an instance, the location of the user may be determined based on RF beacons installed at predefined positions. Accordingly, for example, each beacon may transmit RF signals with a unique characteristic (frequency, polarization, duty cycle, modulation, code etc.). Further, each of these beacons may be short range communication. Accordingly, when the user device receives RF waves of a certain characteristic, the location of the user device may be determined based on the known location of the RF beacon. In other embodiments, the user device may detect its geo-location based on GPS receiver and transmit the location to the transceiver located in the system 104 of the restaurant. Further, in some embodiments, the user device may periodically/continuously transmit a short range communication (like a beacon) which may be sensed by RF detectors installed at predefined locations. Further, the RF detectors may be configured to transmit the sensing of the short range communication to the system 104 of the restaurant. Accordingly, the location of the user device may be determined based on which RF detector transmitted the short range communication.

Furthermore, the method 400 may include a step 408 of transmitting, using the communication unit, the order to the user device. Additionally, the user device may be capable of presenting the order. Further, the method 400 may include a step 410 of receiving, using the communication unit, a confirmation of the order from the user device. Furthermore, the method 400 may include a step 412 of performing, using the processor, at least one action on the at least one message based on the at least one location of the user device and the confirmation of the order.

In some embodiments, the at least one action may include forwarding the at least one message to one or more of an order-taker device and a POS terminal of the restaurant.

In some embodiments, performing the at least one action may be based further on at least one predetermined rule.

In some embodiments, the at least one action may include filtering the at least one message in order to remove one or more of unwanted language and an unnecessary word.

In some embodiments, transforming the at least one message into a structured order may be based on one or more of text processing and speech processing.

In some embodiments, the method may further include: comparing a portion of the at least one message with at least one data element of a menu associated with the restaurant; and generating the structured order based on a result of the comparing.

In some embodiments, the at least one location may include one or more of at least one drive-through lane, at least one intercom station, an interior of the restaurant, at least one order station and at least one pick-up station.

In some embodiments, the at least one message may be one or more of a Short Service Message (SMS), an e-mail, an internet based messaging and a chat-bot based messaging.

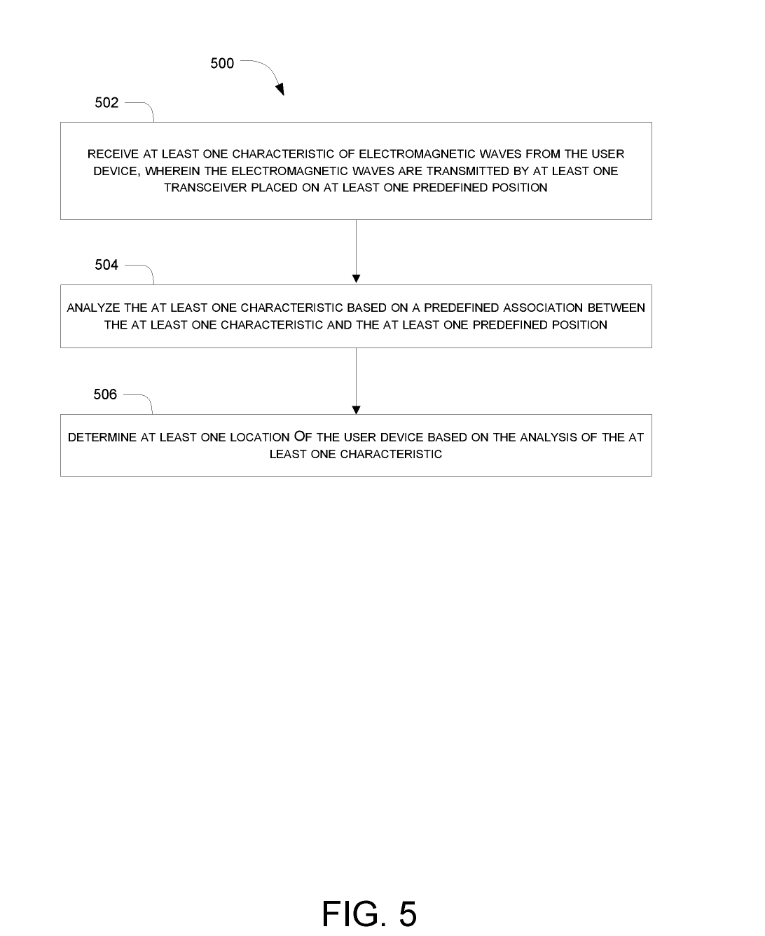

FIG. 5 illustrates a flow chart of a method 500 of determining one or more locations of a user device using one or more transceivers at one or more predefined positions transmitting electromagnetic waves to the user device for facilitating placement of order in a restaurant, in accordance with some embodiments. Accordingly, the one or more locations of the user device may be detected based on a communication between the user device and the one or more transceivers. In some embodiments, the communication may include a short range communication. Further, the one or more transceivers may correspond to the one or more predefined positions in relation to the restaurant. Further, at least one characteristic of electromagnetic waves transmitted by the one or more transceivers may be based on the one or more predefined positions. Further, the user device may be capable of determining the at least one characteristic upon reception of the electromagnetic waves.

Accordingly, the method 500 may include a step 502 of receiving, using the communication unit, the at least one characteristic from the user device. Additionally, the method 500 may include a step 504 of analyzing, using the processor, the at least one characteristic based on a predefined association between the at least one characteristic and the one or more predefined positions. Further, the method 500 may include a step 506 of determining the one or more locations of the user device based on the analyzing.

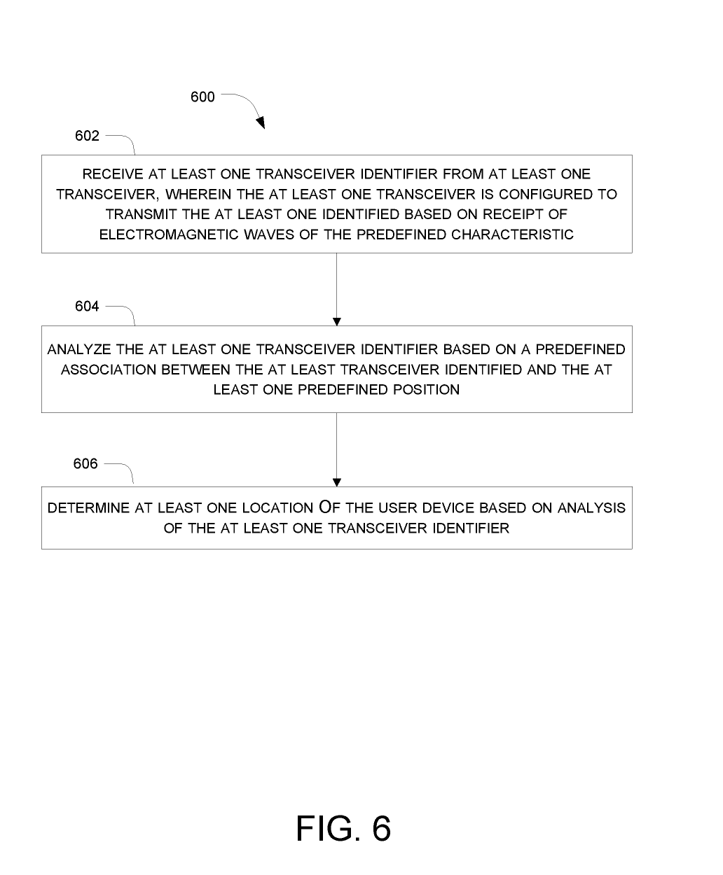

FIG. 6 illustrates a flow chart of a method of determining one or more locations of a user device using one or more transceivers at one or more predefined positions detecting electromagnetic waves transmitted by the user device for facilitating placement of order in a restaurant, in accordance with some embodiments. Accordingly, the one or more locations of the user device may be detected based on a communication between the user device and the one or more transceivers. In some embodiments, the communication may include a short range communication. Further, the one or more transceivers may correspond to the one or more predefined positions in relation to the restaurant. Further, the user device may be capable of transmitting electromagnetic waves of a predefined characteristic.

Accordingly, the method 600 may include a step 602 of receiving, using the communication unit, at least one transceiver identifier from the one or more transceivers. Further, the one or more transceivers may be configured to transmit the at least one identifier based on receipt of electromagnetic waves of the predefined characteristic. Further, the method 600 may include a step 604 of analyzing, using the processor, the at least one transceiver identifier based on a predefined association between the at least transceiver identifier and the one or more predefined positions. Furthermore, the method 600 may include a step 606 of determining the one or more locations based on the analyzing.

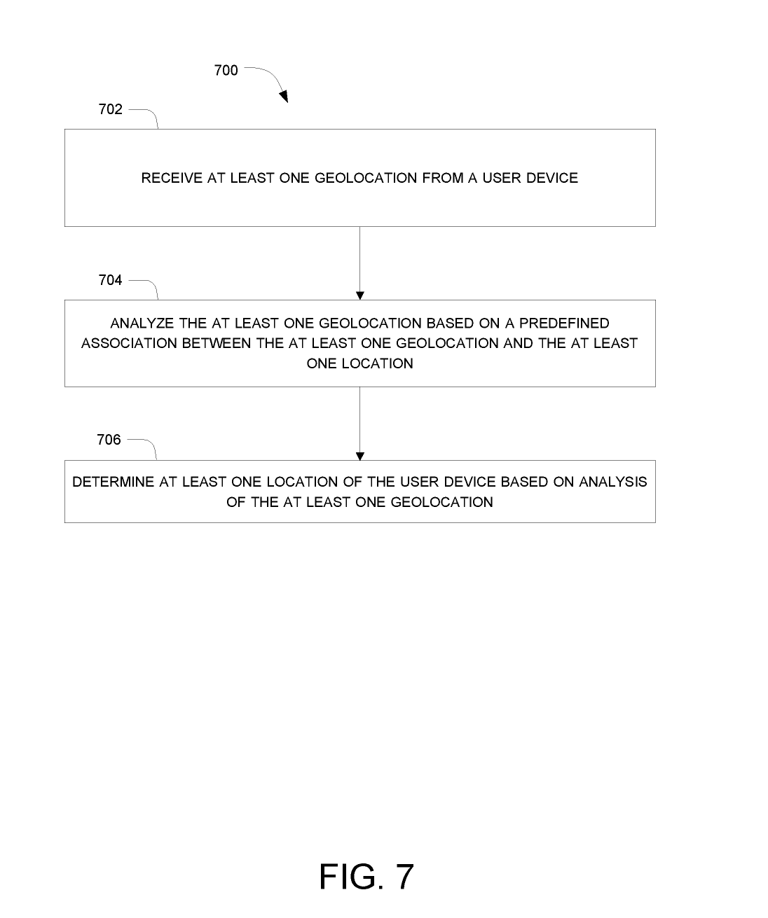

FIG. 7 illustrates a flow chart of a method of determining one or more locations of a user device using GPS for facilitating placement of order in a restaurant, in accordance with some embodiments. Accordingly, the one or more locations of the user device may be detected based on a communication between the user device and the one or more transceivers. Further, in some embodiments, the user device may include a geolocation sensor capable of determining geo-location. Further, the method 700 may include a step 702 of receiving, using the communication unit, at least one geolocation from the user device. Further, the communication unit may be the one or more transceivers. In some embodiments, the user device may be configured for regularly transmitting the at least one geolocation at a predetermined time interval. Additionally, the method 700 may include a step 704 of analyzing, using the processor, the at least one geolocation based on a predefined association between the at least one geolocation and the one or more locations. Further, the method 700 may include a step 706 of determining the one or more locations based on the analyzing.

Accordingly, in some embodiments, the user device senses its own location using a built-in GPS sensor and transmits the location thus sensed to the system 104 through a short-range (e.g. Bluetooth and/or Wifi) or long range communication (e.g. Internet). Alternatively, in some embodiments, the user device may transmit the location to a transceiver located nearby through a short range communication channel and the transceiver may in turn relay the location to the system 104. Accordingly, in some embodiments, there may be no transceivers placed anywhere on the drive-through lane or order stations. The user device may detect its location using GPS and directly transmit the detected location to the system 104 (e.g. by posting the location to a predefined IP/port address).

Additionally, in some embodiments, the at least one location of the user device 106 may be determined by a cell tower providing mobile communication service to the user device 106. Accordingly, the cell tower may communicate with at least two other cell towers in order to detect the at least one location of the user device 106 using techniques such as triangulation. Subsequently, the cell tower may transmit the at least one location thus detected to the user device 106. Alternatively, and/or additionally, the user device 106 may be configured to determine the at least one location based on reception of signals transmitted from at least three cell towers. Thereafter, an application configured on the user device 106 may transmit the at least one location to the system 104. Accordingly, the system 104 may perform the at least one action on the message based on the at least one location.

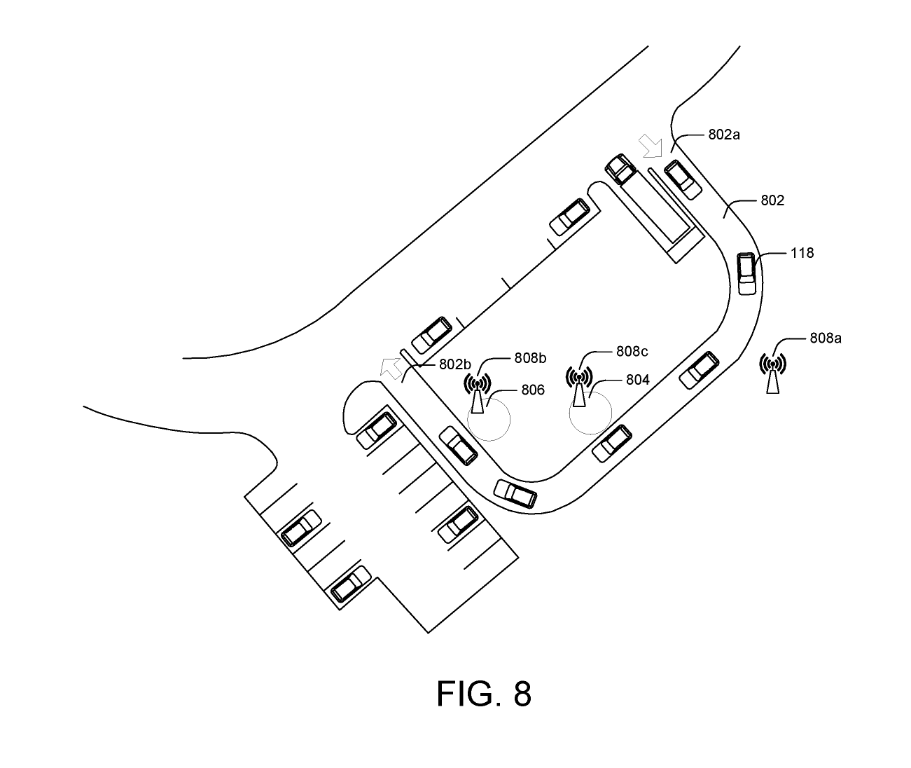

Referring now to FIG. 8, a layout view of a drive-through 800 including a drive-through lane 802. As illustrated, the drive-through lane 802 may include an entrance point 802a and an exit point 802b. Further, the drive-through lane 802 may be designed to allow vehicles, such as cars, to enter the entrance point 802a and drive along the drive-through lane 802 finally exiting through the exit point 802b. In addition, the drive-through 800 may include one or more order stations 804 and one or more order pickup stations 806.

In addition, the drive-through 800 may include one or more transceivers 808. A transceiver 808 may in some embodiments be communicatively coupled to the system 104 as described in conjunction with FIG. 1 such as, for example, the “store and forward” system. Further, the transceiver 808 may be situated at one or more locations along the drive-through lane. For instance, as illustrated the transceiver 808c may be located at a location proximal to the order station 804. Likewise, the transceiver 808b may be located at a location proximal to the order pickup station 806.

In an exemplary scenario, as a user drives a car 118 into the drive-through lane near the entrance point 802a, the user may place an order by entering order details into a mobile device. Subsequently, the mobile device may transmit the order in the form of one or more of a SMS, an email and/or an internet based message to the system, such as the “store and forward” system. Subsequently, the system may detect location of the user proximal to the order station based on a communication between the user device and the transceiver 808c. Accordingly, the system may determine that the user is at the order station and may forward the previously stored order details to the order-taker at the order station. As a result, the order-taker may be able to view the order at a time when the user is present at the order station. Additionally, the order-taker may only be able to view order details without any personal information about the user such as the phone number, email address or social network identity. Further, as explained in conjunction with FIG. 2, once the order-taker accepts the order, the order details may be presented to the user for final confirmation after which, the order may be sent for preparation. Subsequently, the user may drive the car to the order pickup station 806. Accordingly, location of the user in the vicinity of the order pickup station 806 may be detected based on a communication between the user device and the transceiver 808b. Consequently, the user may be served with the ordered items.

The invention can be implemented by software, in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method of facilitating placement of an order at a restaurant, the method comprising:
receiving, using a communication unit, at least one message from a user device, wherein the at least one message comprises the order;
transforming, using a processor, the at least one message into a structured order;
detecting, using the processor, at least one location of the user device based on a communication between the user device and at least one transceiver, wherein the at least one transceiver is configured to perform at least one of transmission and reception of electromagnetic waves;
transmitting, using the communication unit, the order to the user device, wherein the user device is capable of presenting the order; and
receiving, using the communication unit, a confirmation of the order from the user device; and
performing, using the processor, at least one action on the at least one message based on the at least one location of the user device and the confirmation of the order.

2. The method of claim 1, wherein the communication comprises a short range communication, wherein the at least one transceiver corresponds to at least one predefined position in relation to the restaurant, wherein at least one characteristic of electromagnetic waves transmitted by the at least one transceiver is based on the at least one predefined position, wherein the user device is capable of determining the at least one characteristic upon reception of the electromagnetic waves, wherein detecting the at least one location comprises:
receiving, using the communication unit, the at least one characteristic from the user device;
analyzing, using the processor, the at least one characteristic based on a predefined association between the at least one characteristic and the at least one predefined position; and
determining, using the processor, the at least one location based on the analyzing.

3. The method of claim 1, wherein the communication comprises a short range communication, wherein the at least one transceiver corresponds to at least one predefined position in relation to the restaurant, wherein the user device is capable of transmitting electromagnetic waves of a predefined characteristic, wherein detecting the at least one location comprises:
receiving, using the communication unit, at least one transceiver identifier from the at least one transceiver, wherein the at least one transceiver is configured to transmit the at least one identifier based on receipt of electromagnetic waves of the predefined characteristic;
analyzing, using the processor, the at least one transceiver identifier based on a predefined association between the at least transceiver identified and the at least one predefined position; and
determining, using the processor, the at least one location based on the analyzing.

4. The method of claim 1, wherein the user device comprises a geolocation sensor capable of determining geo-location, wherein the detecting comprises:
receiving, using the communication unit, at least one geolocation from the user device, wherein the communication unit is the at least one transceiver;
analyzing, using the processor, the at least one geolocation based on a predefined association between the at least one geolocation and the at least one location; and
determining, using the processor, the at least one location based on the analyzing.

5. The method of claim 4, wherein the user device is configured for regularly transmitting the at least one geolocation at a predetermined time interval.

6. The method of claim 1, wherein the at least one action comprises forwarding the at least one message to at least one of an order-taker device and a POS terminal of the restaurant.

7. The method of claim 1, wherein performing the at least one action is based further on at least one predetermined rule.

8. The method of claim 1, wherein the at least one action comprises filtering the at least one message in order to remove at least one of unwanted language and an unnecessary word.

9. The method of claim 1, wherein transforming the at least one message into a structured order is based on at least one of text processing and speech processing.

10. The method of claim 9 further comprising:
comparing a portion of the at least one message with at least one data element of a menu associated with the restaurant; and
generating the structured order based on a result of the comparing.

11. The method of claim 1, wherein the at least one location comprises at least one of at least one drive-through lane, at least one intercom station, an interior of the restaurant, at least one order station and at least one pick-up station.

12. The method of claim 1, wherein the at least one message is at least one of a Short Service Message (SMS), an e-mail, an internet based messaging and a chat-bot based messaging.

13. A system for facilitating placement of an order at a restaurant, the system comprising:
a communication unit configured for:
receiving at least one message from a user device, wherein the at least one message comprises the order;
transmitting the order to the user device, wherein the user device is capable of presenting the order; and
receiving a confirmation of the order from the user device; and
a processor configured for:
transforming the at least one message into a structured order;
detecting at least one location of the user device based on a communication between the user device and at least one transceiver, wherein the at least one transceiver is configured to perform at least one of transmission and reception of electromagnetic waves; and
performing at least one action on the at least one message based on the at least one location of the user device and the confirmation of the order.

14. The system of claim 13, wherein the communication comprises a short range communication, wherein the at least one transceiver corresponds to at least one predefined position in relation to the restaurant, wherein at least one characteristic of electromagnetic waves transmitted by the at least one transceiver is based on the at least one predefined position, wherein the user device is capable of determining the at least one characteristic upon reception of the electromagnetic waves, wherein the communication unit is configured for receiving the at least one characteristic from the user device, wherein the processor is configured for:
analyzing the at least one characteristic based on a predefined association between the at least one characteristic and the at least one predefined position; and
determining the at least one location based on the analyzing.

15. The system of claim 13, wherein the communication comprises a short range communication, wherein the at least one transceiver corresponds to at least one predefined position in relation to the restaurant, wherein the user device is capable of transmitting electromagnetic waves of a predefined characteristic, wherein the communication unit is configured for receiving at least one transceiver identifier from the at least one transceiver, wherein the at least one transceiver is configured to transmit the at least one identifier based on receipt of electromagnetic waves of the predefined characteristic, wherein the processor is configured for:
analyzing the at least one transceiver identifier based on a predefined association between the at least transceiver identified and the at least one predefined position; and
determining the at least one location based on the analyzing.

16. The system of claim 13, wherein the user device comprises a geolocation sensor configured to determine the geo-location, wherein the communication unit is configured for receiving the geolocation from the user device, wherein the communication unit is the at least one transceiver, wherein the processor is configured for:
analyzing the geolocation based on a predefined association between the at least geolocation and the at least one location; and
determining the at least one location based on the analyzing.

17. The system of claim 16, wherein the user device is capable of regularly transmitting the at least one geolocation at a predetermined time interval.

18. The system of claim 13, wherein the at least one action comprises forwarding the at least one message to at least one of an order-taker device and a POS terminal of the restaurant.

19. The system of claim 13, wherein performing the at least one action is based further on at least one predetermined rule.

20. The system of claim 13, wherein the at least one action comprises filtering the at least one message in order to remove at least one of unwanted language and an unnecessary word.

21. The system of claim 13, wherein transforming the at least one message into a structured order is based on at least one of text processing and speech processing.

22. The system of claim 21, wherein the processor is further configured for:
comparing a portion of the at least one message with at least one data element of a menu associated with the restaurant; and
generating the structured order based on a result of the comparing.

23. The system of claim 13, wherein the at least one location comprises at least one of at least one drive-through lane, at least one intercom station, an interior of the restaurant, at least one order station and at least one pick-up station.

24. The system of claim 13, wherein the at least one message is at least one of a Short Service Message (SMS), an e-mail, an internet based messaging and a chat-bot based messaging.
